(19) United States
(12) Patent Application Publication
(10) Pub. No.: US 2004/0005864 A1
(43) Pub. Date: Jan. 8, 2004

(54) Short range radio receiver

(76) Inventor: Yves Eray, Colombes (FR)

Correspondence Address: John C. Cooper III, Foley & Lardner, Firstar Center, 777 East Wisconsin Avenue, Milwaukee, WI, 53202-5367, US

(21) Appl. No.: 10/276,658

(22) PCT Filed: May 18, 2001
(86) PCT No.: PCT/FR01/01534

(30) Foreign Application Priority Data
May 19, 2000 (FR) 00/06420

(51) Int. Cl. H04B 1/034

(52) U.S. Cl. 455/41.2; 455/575.7; 455/95

(57) ABSTRACT

The short range radio receiver for motor vehicle data signals comprises antenna means (1, 2, 3) having a radiation pattern, connected to a unit (10, 11, 21, 22) for processing received signals, arranged in order to extract the data therefrom, the antenna circuits (1, 2, 3) comprise circuits (3) for rotating the radiation pattern and the processing unit comprises circuits (22) for controlling the rotational drive circuits (3), associated with circuits (21) for measuring the signal level received in at least two positions of the pattern, the measuring circuits (21) driving the control circuits (22) as a function of the measurements.

The present invention relates to short range radio receivers installed on board motor vehicles in order to receive data, such as, for example, data for remotely controlling locking and unlocking of doors.

To lock and unlock the door locks of a motor vehicle from a distance, the driver has a small battery-operated radio transmitter controlling a receiver housed in the vehicle and connected to actuators for operating the locks. The range of the radio link varies with the location of the transmitter since the antenna of the receiver is not perfectly omnidirectional and, furthermore, the metal bulk of the vehicle forms a screen in some directions.

Each type of motor vehicle therefore has, in some directions specific to itself, ranges for a remote control link which are insufficient.

It would be possible to consider increasing the transmitted power, but in practice this solution cannot be adopted since the life of the battery would be too short.

Increasing the sensitivity of the receiver is excluded, since it would increase the sensitivity to radio noise. Furthermore, and additionally, it is desirable not to increase the maximum range, so that the person carrying the transmitter is able to detect any unintentional remote control on his part, from the flashing of the vehicle lights.

The present invention aims to increase the minimum range of the link, while taking into account the above constraints.

To this end, the invention relates to a short range radio receiver for motor vehicle data signals, comprising antenna means having a radiation pattern, connected to a unit for processing received signals, arranged in order to extract the data therefrom, a receiver characterized in that the antenna means comprise circuits for rotating the radiation pattern and the processing unit comprises circuits for controlling the rotational drive circuits, associated with circuits for measuring the signal level received in at least two positions of the pattern, the measuring circuits being arranged in order to drive the control circuits as a function of the measurements.

The dips in sensitivity of the pattern may thus be functionally eliminated and the antenna then tends to be omnidirectional, which increases its minimum range. The rotation of the pattern may possibly be accompanied by a modification of its shape.

In a first embodiment of the receiver of the invention, the antenna means comprise two independent antennas with two respective radiation patterns offset angularly, connected to the processing unit by the rotational drive circuits, arranged in order to select one of the antennas for this purpose.

Thus the receiving pattern is made to rotate by the angular offset of the patterns of the two antennas in order to improve the sensitivity of the receiver.

In a second embodiment, the antenna means comprise two linear radiating elements and the rotational drive circuits connect one of the two elements to the other and to an amplifier for receiving a composite antenna signal, the measurement circuits being arranged in order to modulate the phase of the composite signal through the rotational control circuits, and to determine a phase of maximum reception level.

Thus it is possible to have an antenna with a pattern substantially equivalent to that of an omnidirectional antenna.

The invention will be better understood by means of the following description of a preferred embodiment of the radio receiver of the invention, with reference to the appended drawing, in which:

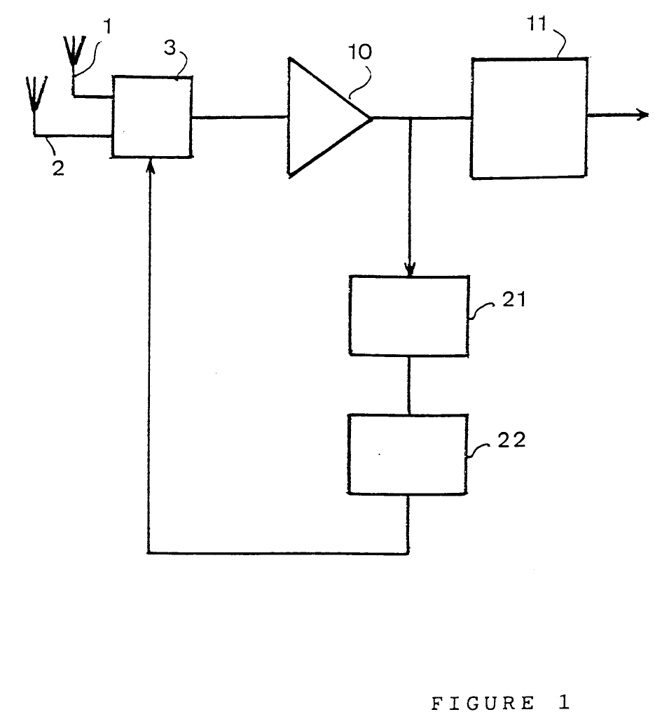

FIG. 1 represents a first and a second embodiment of the receiver of the invention by functional units and

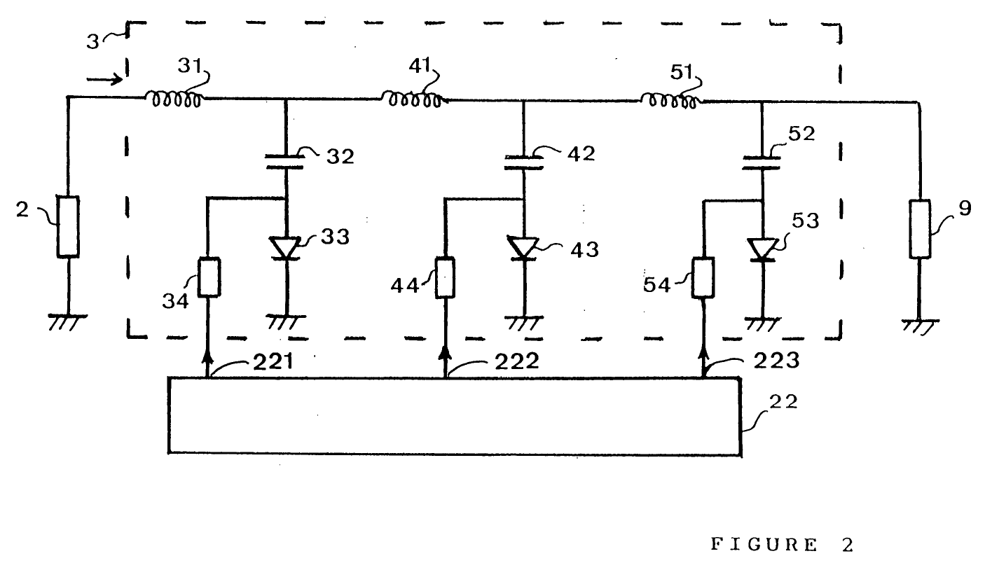

FIG. 2 represents a phase shifting circuit of the second embodiment.

The radio receiver shown is in this case on board a motor vehicle in order to control the locking and unlocking of the door locks. It comprises a pair of antennas 1, 2 associated with an antenna adjustment circuit 3, all connected to the input of conventional receiving and demodulating circuits 10, 11, processing the data radio signal which is received. Reference 10 denotes a low-noise amplifier and reference 11 denotes overall a downstream mixer associated with an intermediate frequency local oscillator, with conventional bandpass filters, and a demodulator for a received modulated carrier signal. The demodulator is followed by decision circuits comprising a level comparator which supplies logic is and Os depending on whether or not the carrier signal received exceeds a fixed or variable threshold as a function of the received signal strength indication (RSSI), detected and stored for this purpose. The control data received via radio are transmitted to an on-board computer which, in this example, controls actuators for locking-unlocking door locks.

A processing unit 21, 22 is connected to an intermediate output of the circuits 10-11 above, in this case at the output of the amplifier 10, with circuits 21 for measuring the radio level received, controlling a microprocessor 22 which itself controls the circuit 3, switching or shifting the phase of the antennas 1, 2, as explained below, in order to rotate the radiation pattern of the overall antenna 1, 2, 3 and thus to adjust the angle of the antenna. Here, the antennas 1 and 2 are linear radiating elements, each one consisting of a track of a printed circuit which bears all the circuits shown.

In the first embodiment, the tracks forming respective antennas 1 and 2 are isolated from each other, therefore independent, and are connected to the processing unit 21, 22 by the circuit 3 which, in this case, is a switch selecting one or other of the antennas 1 and 2. The tracks 1 and 2 forming antennas are linear and lie in respective directions which are substantially perpendicular to each other.

The second embodiment differs from the first one only in the fact that the antenna tracks 1, 2 are substantially parallel and the circuit 3 is a phase shifter which shifts the phase of the signal of one of the antennas 1, 2 with respect to that of the other antenna 2, 1. Specifically here, the antenna 1 is directly connected to the input of the amplifier 10 through the circuit 3 and the phase shifting elements of the phase shifter circuit 3 are inserted between this input and the antenna 2. The amplifier 10 therefore receives a composite signal, representing the vector sum of the signal from the antenna 1 and of the phase shifted signal from the antenna 2. Here, since the antennas 1 and 2 are of identical lengths, the signals received by the antennas 1 and 2 are identical, except for the phase shift corresponding to the distance between the antennas 1, 2. This phase shift, which depends on the carrier frequency, represents the difference in distance of the antennas 1, 2 from a radio signal transmitter. To simplify the explanation, it will be assumed that this phase shift is small or that the direction of the transmitter is substantially fixed and that this phase shift, associated with the hardware configuration of the antennas 1, 2, is therefore constant.

The operation of the receiver will now be explained in more detail.

In the two embodiments, the circuits 21 measure the reception level at the output of the amplifier 10 when they control or drive the microprocessor 22 so that it controls passage or the keeping of the antenna adjustment circuit 3 in a particular state. It will be noted that the reception level can be measured before demodulation, as here, or as a variant, after demodulation (RSSI signal). In the first embodiment, the circuit 3 successively takes two states, in order to select one or other of the antennas 1 and 2. In the second embodiment, the circuit 3 takes at least two states so that the composite signal is able to correspond successively to at least two different phase shifts between the signals of the antennas 1 and 2.

In this example, the adjustment circuit 3 is provided in order to give, on demand, a phase shift of about 180 degrees to the signal of the antenna 2. The antennas 1 and 2 receive two respective signals and the equivalent overall antenna 1, 2, 3 has a radiation pattern having two opposite main lobes, in a direction of maximum sensitivity, and minimum sensitivity in the direction perpendicular thereto. If the phase of one of the two antenna signals applied to the amplifier 10 is then shifted by 180 degrees, the two antenna signals are then compounded in a subtractive manner with regard to the previous direction of maximum sensitivity and, in contrast, they are now added in phase in the previous direction of minimum sensitivity. The radiation pattern of the overall antenna 1, 2, 3 thus rotates by half the phase shift variation of the adjustment circuit 3. However, it should be noted that the above rotation of 90 degrees of the overall pattern is only one particular case since, in general, it is enough to rotate the pattern so that an insufficient sensitivity minimum in one direction is replaced by a sensitivity value exceeding a minimum threshold for detecting signals in the circuits 10, 11 which exploit them. For example, a rotation of 45 degrees may be sufficient.

Since the signals to be detected originate from a transmitter carried by the car owner, a priori substantially at the same height as the car, it is therefore the azimuthal angle of the antenna which it is appropriate to adjust. The two antennas 1, 2 are therefore placed one with respect to the other such that the radiation pattern is rotated about a substantially vertical axis.

The measuring circuits 21 control the microprocessor 22 so that the adjustment circuit 3 successively takes two different states and that they store at least the first measurement in order to compare it with the second and thus choose the state of the adjustment circuit 3 providing the higher reception level of the two. Control of the measuring circuit 21 applied for this purpose to the microprocessor 22 therefore remains unchanged if the second measurement is greater than the first. Otherwise, it passes back to that of the earlier state.

Thus the radiation pattern is rotated by the processing unit 21, 22 and a dip in sensitivity of the antenna 1, 2, 3 in a particular direction is rotated so as to receive useful signals coming from this direction.

In the case of the first embodiment, the adjustment selector circuit 3 may, as a variant, be provided in order to select more than two antennas, for example three antennas with lobes distributed angularly, offset by 60 degrees, and no more than 90 degrees. The increase in the number of antennas makes it possible to choose that antenna which is substantially oriented toward the transmitter, therefore with optimum sensitivity or gain. If the need arose, it would also be possible to make provision for the third antenna to be arranged so as to allow scanning in elevation, therefore with an axis which is horizontal or simply inclined to the vertical, in addition to the azimuthal scanning obtained by the cooperation of antennas 1 and 2.

In the case of the second embodiment, the same principle, of increasing the number of directions in which the antenna 1, 2 points, is applicable but does not require the addition of antennas, in so far as provision is made for the phase shifting circuit 3 to be adjustable to more than two phase shifting states, and possibly even continuously, in order to drive the lobe of the overall antenna 1, 2, 3, providing the composite signal, in a continuous rotational movement, or step by step. The measurement circuits 21 control such a rotational scanning movement and cyclically measure and store the received level in order, after such angular scanning, to command the microprocessor 22 to apply to the phase shifter circuit 3 a command corresponding to an orientation of the composite lobe in the direction of maximum sensitivity. The measurement circuits 21 thus modulate, through the rotational control microprocessor 22, the phase of the composite signal in order to determine a phase of maximum reception level and thus to adjust the antenna 1, 2, 3 to its maximum sensitivity.

The phase shifter circuit 3 of FIG. 2, operating at a few hundred MHz, connects the antenna 2 to an output load impedance 9, at the input of the amplifier 10, the impedances of the antenna 2 and load 9 respectively being matched to the characteristic input and output impedances, 50 ohms, of the phase shifter circuit 3.

Here, the phase shifter circuit 3 comprises three elementary phase shift cells, each of which can be switched from 0 or 90 degrees. Each cell has a series self impedance 31, 41, 51 with, downstream, a capacitor 32, 42, 52 connected to earth through a PIN diode 33, 43, 53 with cathode connected to earth. The anode of the diode 33, 43, 53 is connected to a respective control output 221, 222, 223 of the microprocessor 22 through a bias resistor 34, 44, 54 having a high value with respect to the impedances of the other elements of the phase shifter circuit 3, so as to prevent a permanent short circuit effect, via the microprocessor 22, of the alternating signals passing through the self impedances 31, 41, 51.

The three control signals from the outputs 221, 222, 223 of the microprocessor 22 have a substantially zero quiescent level. The diodes 33, 43, 53, having low parasitic capacitance and therefore high impedance, cannot then conduct the radio signals, their diode threshold being greater than the amplitude of the antenna signals. On the other hand, if an output such as 221 passes to a high level of a few volts, the corresponding diode, in this case 33, is then biased by a d.c. current and is therefore conducting. Its dynamic resistance, around the bias current quiescent point, is adjusted by selecting the values of the bias resistors such as 34, and is smaller the greater the bias current. Each diode 33, 43, 53 therefore constitutes a switch controlled by the microprocessor 22 in order to bring into service (connected on the one side to earth) the associated by-pass capacitor 32, 42, 52 and thus to introduce a phase rotation of 90 degrees in the cell in question. In addition, or as a variant, an adjustable attenuator can be provided in the place of each diode 33, 43, 53 in order to gradually bring the capacitors 32, 42, 52 into service and thus to continuously adjust the phase shift. A gradual increase of the current biasing the diodes 33, 43, 53 via analogue outputs 221, 222, 223 of an analogue/digital converter would likewise make it possible to modulate, as required, the dynamic resistance of the diodes 33, 43, 53 in order to constitute an adjustable attenuator in series with the capacitors 32, 42, 52.

Since the mechanically static directional antenna 1, 2 has a sensitivity which varies with the angle of the receiving direction, it is thus transformed, by the radiation pattern rotational drive circuit 3, into an electronically moveable and thus omnidirectional antenna. In some applications, provision may be made for the antenna also to transmit toward the transmitter of the signals that it receives.

1. A short range radio receiver for motor vehicle data signals, comprising antenna means (1, 2, 3) having a radiation pattern, connected to a unit (10, 11, 21, 22) for processing received signals, arranged in order to extract the data therefrom, a receiver characterized in that the antenna means (1, 2, 3) comprise circuits (3) for rotating the radiation pattern and the processing unit comprises circuits (22) for controlling the rotational drive circuits (3), associated with circuits (21) for measuring the signal level received in at least two positions of the pattern, the measuring circuits (21) being arranged in order to drive the control circuit (22) as a function of the measurements.

2. The receiver as claimed in claim 1, in which the antenna means comprise two independent antennas (1, 2) with two respective radiation patterns offset angularly, connected to the processing unit (10, 11, 21, 22) by the rotational drive circuits (3), arranged in order to select one of the antennas (1, 2) for this purpose.

3. The receiver as claimed in claim 2, in which the antennas (1, 2) are substantially perpendicular printed circuit tracks.

4. The receiver as claimed in claim 1, in which the antenna means comprise two linear radiating elements (1, 2) and the rotational drive circuits (3) connect one of the two elements (2) to the other (1) and to an amplifier (10) for receiving a composite antenna signal.

5. The receiver as claimed in claim 4, in which the antenna elements (1, 2) are substantially parallel printed circuit tracks.

6. The receiver as claimed in claim 4, in which the measurement circuits (21) are arranged in order to modulate the phase of the composite signal through the rotational control circuits (22), and to determine a phase of maximum reception level.
